(19) United States
(12) Patent Application Publication
(10) Pub. No.: US 2021/0188362 A1
(43) Pub. Date: Jun. 24, 2021

(54) VEHICLE SEAT

(71) Applicant: TS TECH CO., LTD., Asaka-shi (JP)

(72) Inventor: Dustin Webb, Pataskala, OH (US)

(21) Appl. No.: 16/854,402

(22) Filed: Apr. 21, 2020

Related U.S. Application Data
(60) Provisional application No. 62/951,525, filed on Dec. 20, 2019.

(51) Int. Cl. B62D 25/20; B60N 2/015

(52) U.S. Cl. CPC B62D 25/2009; B60N 2/01541; B60N 2/01583

(57) ABSTRACT

A vehicle seat is detachably attached to a floor of a vehicle. The vehicle seat includes a seat body configured to support an occupant and a lock mechanism disposed below the seat body and detachably attached to a first striker provided on the floor. The lock mechanism includes a first lock part that has a first lock groove configured to be engaged with the first striker and a cover configured to be displaced between an exposing position to expose the first lock groove and a covering position to cover at least a part of the first lock groove.

### CROSS-REFERENCE TO RELATED APPLICATION

This application claims the benefit of priority to U.S. Provisional Patent Application No. 62/951,525, filed on Dec. 20, 2019. The contents of the provisional application are hereby incorporated by reference in their entirety.

### TECHNICAL FIELD

The present invention relates to a vehicle seat detachably attached to a floor of a vehicle.

### BACKGROUND ART

Conventionally, there is a vehicle seat detachably attached to a floor of a vehicle. For example, there is a vehicle seat that includes a lock mechanism detachably attached to a striker provided on a floor of a vehicle so as to lock the vehicle seat to the floor (see, JP2006-69499A).

In such a conventional vehicle seat, if an object other than the striker abuts against a particular part of the lock mechanism by accident, the lock mechanism may be activated by mistake in a state where the vehicle seat is detached from the floor.

### SUMMARY OF THE INVENTION

In view of such a problem of the prior art, a primary object of the present invention is to provide a vehicle seat that can prevent a lock mechanism from being activated by mistake in a state where the vehicle seat is detached from the floor.

To achieve such an object, one embodiment of the present invention provides a vehicle seat (1) detachably attached to a floor (F) of a vehicle (V), including: a seat body (3) configured to support an occupant; and a lock mechanism (6) disposed below the seat body, detachably attached to a first striker (S1) provided on the floor, and including a first lock part (34) that has a first lock groove (35) configured to be engaged with the first striker, and a cover (23) configured to be displaced between an exposing position to expose the first lock groove and a covering position to cover at least a part of the first lock groove.

According to this arrangement, by displacing the cover to the covering position, it is possible to prevent an object other than the first striker from abutting against a particular part of the lock mechanism by accident. Therefore, it is possible to prevent the lock mechanism from being activated by mistake in a state where the vehicle seat is detached from the floor.

Preferably, the lock mechanism further includes a second lock part (38) that has a second lock groove (39) configured to be engaged with a second striker (S2) provided on the floor, a lever (25) disposed at the second lock part and configured to be displaced between an activated position and an inactivated position, and a connecting member (26) connecting the cover and the lever, and when the second striker is engaged with the second lock groove, the second striker pushes the lever to displace the lever from the inactivated position to the activated position, and thereby, the lever pulls the cover via the connecting member to displace the cover from the covering position to the exposing position.

According to this arrangement, it is possible to displace the cover from the covering position to the exposing position by an attachment operation of the vehicle seat. Therefore, it is possible to more securely prevent the lock mechanism from being activated by mistake in the state where the vehicle seat is detached from the floor.

Preferably, the lock mechanism further includes an urging member (24) configured to urge the cover to the covering position, and when engagement of the first striker with the first lock groove and engagement of the second striker with the second lock groove are released, the cover is displaced from the exposing position to the covering position by an urging force of the urging member.

According to this arrangement, it is possible to displace the cover from the exposing position to the covering position by a detachment operation of the vehicle seat. Therefore, it is possible to more securely prevent the lock mechanism from being activated by mistake in the state where the vehicle seat is detached from the floor.

Preferably, the cover is configured to rotate between the exposing position and the covering position, and the lever is configured to rotate between the activated position and the inactivated position.

According to this arrangement, it is possible to displace the first and levers in small spaces.

Preferably, a rotational direction of the cover from the covering position to the exposing position is the same as a rotational direction of the lever from the inactivated position to the activated position.

According to this arrangement, it is possible to efficiently transmit rotation from the lever to the cover by a simple action.

Preferably, the cover includes a first upper arm (44) extending upward from a rotational center of the cover, the lever includes a second upper arm (48) extending upward from a rotational center of the lever, a first end in a longitudinal direction of the connecting member is connected to the first upper arm, and a second end in the longitudinal direction of the connecting member is connected to the second upper arm.

According to this arrangement, it is possible to stably activate the first and levers.

Preferably, the lever is disposed in front of the cover, and the connecting member is composed of a cable extending in a fore and aft direction.

According to this arrangement, it is possible to displace the connecting member in a small space and to make the configuration of the connecting member simple.

Preferably, in a state where the lever is disposed in the inactivated position, the lever extends in a direction crossing a direction along which the second striker engages with the second lock groove.

According to this arrangement, it is possible to more securely prevent the lock mechanism from being activated by mistake in the state where the vehicle seat is detached from the floor and to more securely displace the lever from the inactivated position to the activated position when the second striker is engaged with the second lock groove.

Preferably, the vehicle seat further includes a slide rail (4) configured to slidably support the seat body, wherein the connecting member is disposed below the slide rail.

According to this arrangement, it is possible to protect the connecting member by the slide rail, and thereby to prevent the connecting member from being damaged or deformed by an outside force.

Preferably, the vehicle seat further includes: a slide rail (4) configured to slidably support the seat body; and a rail cover (5) configured to cover at least a part of the slide rail, wherein the connecting member is disposed inside the rail cover.

According to this arrangement, it is possible to protect the connecting member by the rail cover, and thereby to prevent the connecting member from being damaged or deformed by an outside force.

Preferably, the cover is formed in a bag shape and configured to cover an entirety of the first lock groove in a state where the cover is disposed in the covering position.

According to this arrangement, it is possible to securely prevent the object other than the first striker from abutting against the particular part of the lock mechanism by accident in the state where the cover is disposed in the covering position.

Preferably, the cover is formed in a plate shape and configured to cover only a part of the first lock groove in a state where the cover is disposed in the covering position.

According to this arrangement, it is possible to make the configuration of the cover simple.

Thus, the present invention provides a vehicle seat that can prevent a lock mechanism from being activated by mistake in a state where the vehicle seat is detached from the floor.

### BRIEF DESCRIPTION OF THE DRAWINGS

FIG. 1 is a right side view of a vehicle seat attached to a floor of a vehicle according to an embodiment of the present invention;

FIG. 2 is a right side view of the vehicle seat detached from the floor according to the embodiment of the present invention;

FIG. 3A is a left side view of a rear part of a lock mechanism in a state where a latch member is disposed in a release position;

FIG. 3B is a left side view of the rear part of the lock mechanism in a state where the latch member is disposed in an engagement position;

FIG. 4 is a right side view of the vehicle seat in the middle of being attached to the floor according to the embodiment of the present invention;

FIG. 5A is a right side view of a rear part of a lock mechanism in a state where a cover is disposed in an exposing position according to another embodiment of the present invention; and

FIG. 5B is a right side view of the rear part of the lock mechanism in a state where the cover is disposed in a covering position according to another embodiment of the present invention.

### DESCRIPTION OF THE PREFERRED EMBODIMENT(S)

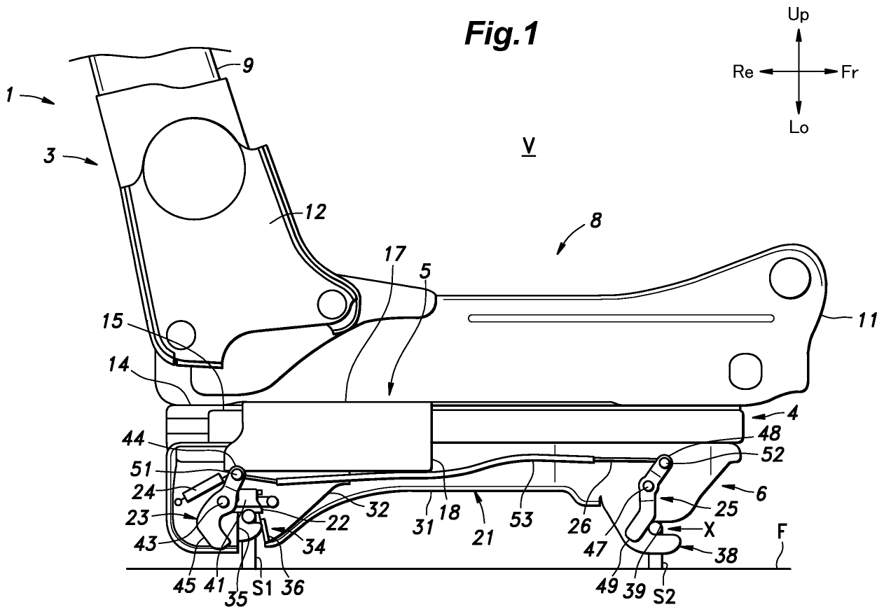

In the following, a vehicle seat 1 according to an embodiment of the present invention will be described with reference to FIGS. 1 to 4. Arrows Fr, Re, Up, and Lo, which are appropriately attached to the drawings, indicate the front side, rear side, upper side, and lower side of the vehicle seat 1, respectively. Directional terms (for example, front, rear, upper, lower, right, and left) will be used based on a viewpoint of an occupant (not shown) sitting on the vehicle seat 1.

### (Vehicle Seat 1)

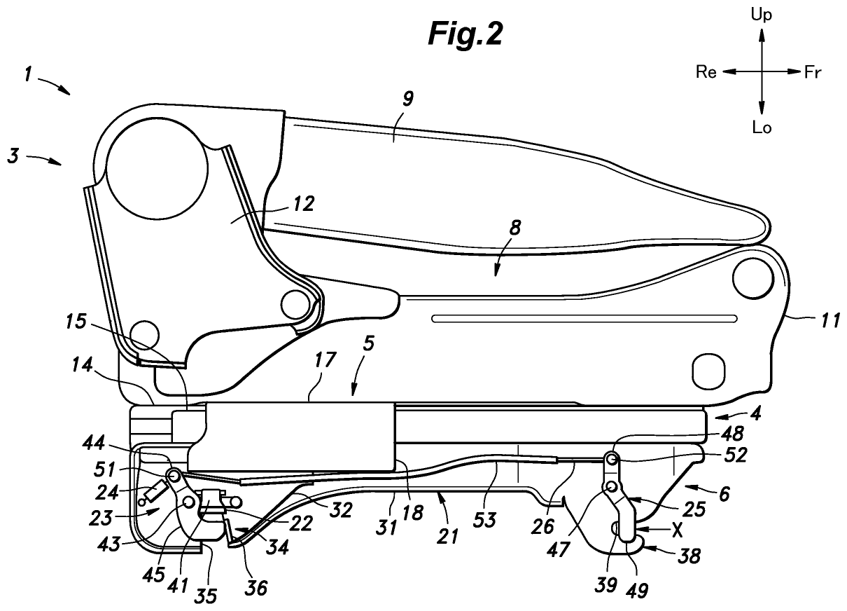

As shown in FIGS. 1 and 2, the vehicle seat 1 is detachably attached to a floor F of a vehicle V such as an automobile. A pair of left and right first strikers S1 (only the right first striker S1 is shown in the drawings) and a pair of left and right second strikers S2 (only the right second striker S2 is shown in the drawings) are provided on the floor F. Each second striker S2 is disposed in front of each first striker S1. Each of the front and rear strikers S1, S2 has a U-shape. In the drawings, only a half of each of the front and rear strikers S1, S2 are shown.

The vehicle seat 1 includes a seat body 3 configured to support the occupant, a pair of left and right slide rails 4 (only the right slide rail 4 is shown in the drawings) configured to slidably support the seat body 3, a pair of left and right rail covers 5 (only the right rail cover 5 is shown in the drawings) configured to cover a rear part of each slide rail 4, and a pair of left and right lock mechanisms 6 (only the right lock mechanism 6 is shown in the drawings) disposed below the seat body 3 and detachably attached to each of the front and rear strikers S1, S2. Hereinafter, the above components of the vehicle seat 1 will be described in order.

### (Seat Body 3)

As shown in FIGS. 1 and 2, the seat body 3 includes a seat cushion 8 on which the occupant sits and a seat back 9 disposed above the seat cushion 8. The seat cushion 8 includes a pair of left and right side frames 11 (only the right side frame 11 is shown in the drawings) extending in the fore and aft direction and a pair of front and rear connecting frames (not shown) extending in the lateral direction so as to connect the pair of left and right side frames 11. The seat back 9 is attached to a rear end of the seat cushion 8 via a pair of left and right hinge members 12 (only the right hinge member 12 is shown in the drawings). The seat back 9 is configured to rotate with respect to the seat cushion 8 between an upright position (see FIG. 1) to extend upward from the rear end of the seat cushion 8 and a folded position (see FIG. 2) to be folded onto the seat cushion 8.

### (Slide Rails 4)

As shown in FIGS. 1 and 2, each slide rail 4 is disposed right below each side frame 11 of the seat cushion 8 and extends in the fore and aft direction. Each slide rail 4 includes an upper rail 14 and a lower rail 15. The upper rail 14 is fixed to a lower end of each side frame 11 of the seat cushion 8. The lower rail 15 supports the upper rail 14 such that the upper rail 14 is slidable in the fore and aft direction.

### (Rail Covers 5)

As shown in FIGS. 1 and 2, each rail cover 5 extends in the fore and aft direction. Each rail cover 5 includes an upper plate 17 disposed horizontally and a side plate 18 extending downward from an outside end in the lateral direction of the upper plate 17. The upper plate 17 is interposed between each side frame 11 of the seat cushion 8 and the upper rail 14 of each slide rail 4. The side plate 18 covers the rear part of each slide rail 4 from outside in the lateral direction.

### (Lock Mechanisms 6)

As shown in FIGS. 1, 2, 3A and 3B, each lock mechanism 6 includes a base member 21 extending in the fore and aft direction, an elastic member 22 attached to a rear part of the base member 21, a cover 23 rotatably attached to the rear part of the base member 21, an urging member 24 interposed between the base member 21 and the cover 23, a lever 25 rotatably attached to a front part of the base member 21, a connecting member 26 connecting the cover 23 and the lever 25, a latch member 27 and a lock member 28 rotatably attached to the rear part of the base member 21, and a spring member 29 interposed between the latch member 27 and the lock member 28.

As shown in FIGS. 1 and 2, the base member 21 of each lock mechanism 6 is disposed right below each slide rail 4. The base member 21 includes an inner plate 31 extending in the fore and aft direction and an outer plate 32 attached to a rear part of the inner plate 31 from outside in the lateral direction. An upper end of the inner plate 31 is attached to a lower end of the lower rail 15 of each slide rail 4. An upper end of the outer plate 32 is engaged with a lower end of the side plate 18 of each rail cover 5.

In a rear part of the base member 21, a first lock part 34 is formed by both of the inner plate 31 and the outer plate 32. The first lock part 34 has a first lock groove 35 configured to be engaged with each first striker S1. The first lock groove 35 extends vertically and is opened downward. The first lock part 34 is provided with a stopper 36 disposed at a front edge of the first lock groove 35. In a front part of the base member 21, a second lock part 38 is formed by the inner plate 31. The second lock part 38 has a second lock groove 39 configured to be engaged with each second striker S2. Arrows X shown in FIGS. 1, 2, and 4 show a direction (hereinafter referred to as “engagement direction X”) along which each second striker S2 is engaged with the second lock groove 39. The second lock groove 39 extends horizontally and opened forward. That is, the first and second lock grooves 35, 39 are opened to different directions.

As shown in FIGS. 1 and 2, the elastic member 22 of each lock mechanism 6 is attached to an outer face of the base member 21 by an attachment plate 41. The elastic member 22 is made of rubber or elastomer, for example. The elastic member 22 is configured to cover an upper part of the first lock groove 35 from outside in the lateral direction.

The cover 23 of each lock mechanism 6 is made of steel and formed in a plate shape, for example. The cover 23 is disposed at the first lock part 34. The cover 23 is attached to the outer face of the base member 21 via a first rotation axis 43 so as to rotate around the first rotation axis 43. The cover 23 includes a first upper arm 44 extending upward from the first rotation axis 43 (namely, the rotational center of the cover 23) and a first lower arm 45 extending downward from the first rotation axis 43. The cover 23 is configured to rotate between an exposing position (see FIG. 1) to expose the entirety of the first lock groove 35 and a covering position (see FIG. 2) to cover a lower part of the first lock groove 35 by the first lower arm 45 from outside in the lateral direction. In a state where the cover 23 is disposed in the covering position, the first lower arm 45 abuts against the stopper 36.

The urging member 24 of each lock mechanism 6 is composed of a coil spring, for example. A first axial end of the urging member 24 is attached to the base member 21 and a second axial end of the urging member 24 is attached to the first upper arm 44 of the cover 23. The urging member 24 is configured to urge the cover 23 to the covering position (see FIG. 2).

The lever 25 of each lock mechanism 6 is made of steel and formed in a plate shape, for example. The lever 25 is disposed at the second lock part 38. The lever 25 is attached to the outer face of the base member 21 via a second rotation axis 47 so as to rotate around the second rotation axis 47. The lever 25 includes a second upper arm 48 extending upward from the second rotation axis 47 (namely, the rotational center of the lever 25) and a second lower arm 49 extending downward from the second rotation axis 47. The lever 25 is configured to rotate between an activated position (see FIG. 1) to expose the entirety of the second lock groove 39 and an inactivated position (see FIG. 2) to cover a center part of the second lock groove 39 by the second lower arm 49 from outside in the lateral direction. In a state where the lever 25 is in the inactivated position, the lever 25 extends in a direction crossing the engagement direction X.

The connecting member 26 of each lock mechanism 6 is composed of a cable, for example. The connecting member 26 extends in the fore and aft direction along the outer face of the base member 21. The connecting member 26 is disposed below each slide rail 4. A rear end (a first end in the longitudinal direction) of the connecting member 26 is connected to the first upper arm 44 of the cover 23 via a first attachment 51. A front end (a second end in the longitudinal direction) of the connecting member 26 is connected to the second upper arm 48 of the lever 25 via a second attachment 52. A center part in the longitudinal direction of the connecting member 26 is inserted into a tube 53 extending in the fore and aft direction.

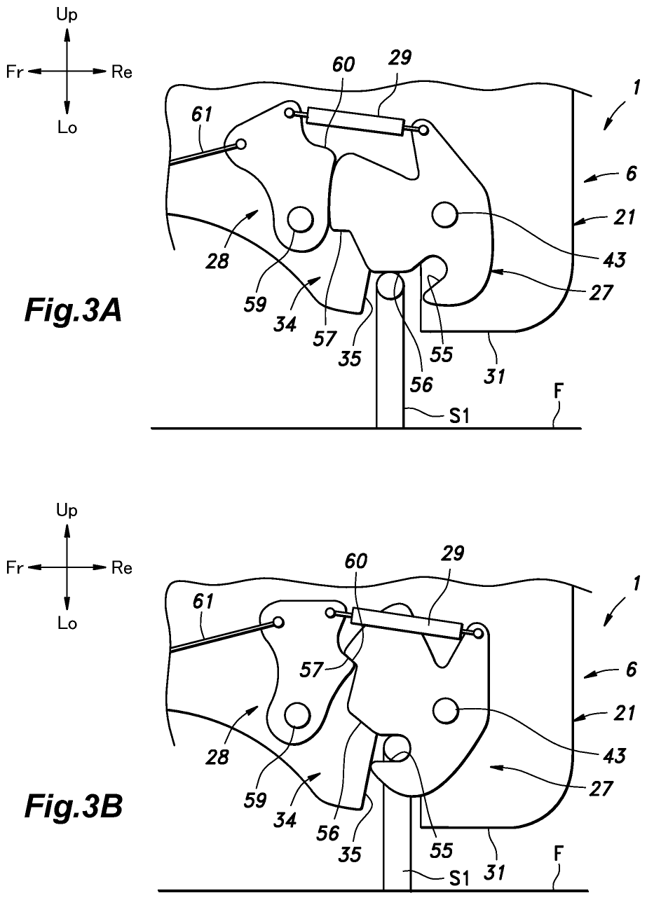

As shown in FIGS. 3A and 3B, the latch member 27 of each lock mechanism 6 is attached to an inner face of the base member 21 via the first rotation axis 43 so as to rotate around the first rotation axis 43. A latch groove 55 is provided on a front face of the latch member 27. The latch member 27 is configured to rotate between a release position (see FIG. 3A) to release the engagement of the latch groove 55 with each first striker S1 and an engagement position (see FIG. 3B) to engage the latch groove 55 with each first striker S1. The latch groove 55 extends in the fore and aft direction and opened forward, in a state where the latch member 27 is disposed in the engagement position. An abutting face 56 is provided on the rear face of the latch member 27 so as to be adjacent to the latch groove 55. A recess 57 is provided on the rear face of the latch member 27 so as to be adjacent to the abutting face 56.

The lock member 28 of each lock mechanism 6 is attached to the inner face of the base member 21 via a third rotation axis 59 so as to rotate around the third rotation axis 59. A protrusion 60 is provided on a rear face of the lock member 28 so as to be engaged with the recess 57 of the latch member 27. The lock member 28 is connected to an operation member (not shown) such as a lever or a button via a wire cable 61.

The spring member 29 of each lock mechanism 6 is composed of a coil spring, for example. The spring member 29 urges the latch member 27 to the release position (see FIG. 3A).

### (Attachment/Detachment Operation of Vehicle Seat 1)

In the following, attachment/detachment operation of the vehicle seat 1 will be described in detail. Incidentally, the actions of the pair of left and right lock mechanisms 6 during the attachment/detachment operation of the vehicle seat 1 are similar to each other. Hereinafter, the action of only one lock mechanism 6 will be described.

As shown in FIG. 2, in a state where the vehicle seat 1 is detached from the floor F, the cover 23 is disposed in the covering position by an urging force of the urging member 24. Thereby, the cover 23 covers the lower part of the first lock groove 35 to prevent the first striker S1 from abutting against the abutting face 56 of the latch member 27 (i.e. to prevent the lock mechanism 6 from being activated). Also, in the state where the vehicle seat 1 is detached from the floor F, the lever 25 is disposed in the inactivated position. Also, in the state where the vehicle seat 1 is detached from the floor F, the seat back 9 is disposed in the folded position. Also, in the state where the vehicle seat 1 is detached from the floor F, the latch member 27 is disposed in the release position (see FIG. 3A) by an urging force of the spring member 29.

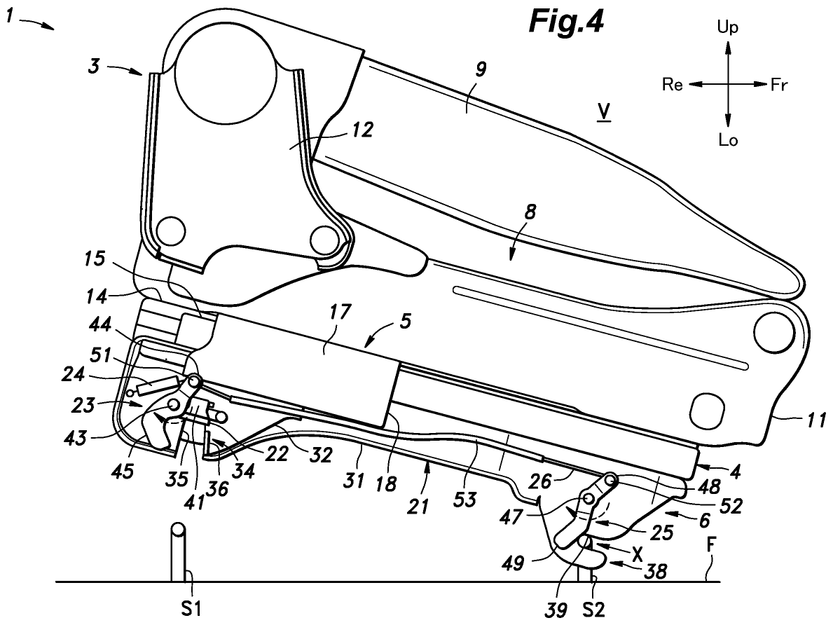

When a worker such as an occupant performs the attachment operation of the vehicle seat 1, as shown in FIG. 4, the worker first engages the second striker S2 with the second lock groove 39 along the engagement direction X. When the second striker S2 is engaged with the second lock groove 39 in this way, the second striker S2 pushes the lever 25 to rotate the lever 25 from the inactivated position to the activated position. Thereby, the lever 25 pulls the cover 23 via the connecting member 26, and the cover 23 rotates from the covering position to the exposing position against the urging force of the urging member 24 to allow the first striker S1 to abut against the abutting face 56 of the latch member 27 (i.e. to allow the lock mechanism 6 to be activated). Incidentally, a rotational direction of the cover 23 from the covering position to the exposing position is the same as a rotational direction of the lever 25 from the inactivated position to the activated position (see dotted arrows in FIG. 4).

Next, the worker lowers the rear part of the vehicle seat 1. Thereby, as shown in FIG. 3A, the first striker S1 is engaged with the first lock groove 35 and abuts against the abutting face 56 of the latch member 27. When the worker further lowers the rear part of the vehicle seat 1, as shown in FIG. 3B, the first striker S1 pushes the latch member 27 to rotate the latch member 27 from the release position to the engagement position against the urging force of the spring member 29. Thereby, the recess 57 of the latch member 27 is engaged with the protrusion 60 of the lock member 28 to hold the latch member 27 in the engagement position. In this way, the lock mechanism 6 is activated.

Next, as shown in FIG. 1, the worker rotates the seat back 9 from the folded position to the upright position. Thereby, the attachment operation of the vehicle seat 1 to the floor F is completed.

When the worker performs the detachment operation of the vehicle seat 1, the worker first rotates the seat back 9 from the upright position to the folded position.

Next, the worker operates the operation member (not shown) connected to the lock member 28 via the wire cable 61. When the operation member is operated in this way, the operation member pulls the lock member 28 via the wire cable 61. Thereby, as shown in FIG. 3A, the engagement of the recess 57 of the latch member 27 with the protrusion 60 of the lock member 28 is released to rotate the latch member 27 from the engagement position to the release position by the urging force of the spring member 29. In this way, the lock mechanism 6 stops being activated.

Next, as shown in FIG. 4, the worker raises the rear part of the vehicle seat 1. Thereby, the engagement of the first striker S1 with the first lock groove 35 is released.

Next, as shown in FIG. 2, the worker releases the engagement of the second striker S2 with the second lock groove 39. Thereby, the second striker S2 stops pushing the lever 25, and the lever 25 stops pulling the cover 23 via the connecting member 26. Thereby, the cover 23 rotates from the exposing position to the covering position by the urging force of the urging member 24 to prevent the first striker S1 from abutting against the abutting face 56 of the latch member 27 (i.e. to prevent the lock mechanism 6 from being activated). Also, when the cover 23 rotates from the exposing position to the covering position as described above, the cover 23 pulls the lever 25 via the connecting member 26 to rotate the lever 25 from the activated position to the inactivated position. Thereby, the detachment operation of the vehicle seat 1 is completed.

### (Effect)

In the present embodiment, the cover 23 is configured to rotate between the exposing position to expose the first lock groove 35 and the covering position to cover the lower part of the first lock groove 35. Accordingly, by rotating the cover 23 to the covering position, it is possible to prevent an object other than the first striker S1 from abutting against the abutting face 56 of the latch member 27 by accident. Therefore, it is possible to prevent the lock mechanism 6 from being activated by mistake in the state where the vehicle seat 1 is detached from the floor F. Thereby, it is possible to prevent a situation where the first striker S1 abuts against the latch member 27 that has already rotated from the release position to the engagement position when the vehicle seat 1 is attached to the floor F. Also, it is possible to protect the first lock groove 35 by the cover 23 and thereby to prevent the first lock groove 35 from being damaged or broken.

Also, the first striker S1 cannot be appropriately engaged with the first lock groove 35 unless the second striker S2 is engaged with the second lock groove 39. Thereby, it is possible to urge the worker to engage the first striker S1 to the first lock groove 35 after engaging the second striker S2 to the second lock groove 39. That is, it is possible to urge the worker to attach the vehicle seat 1 to the floor F with a correct procedure.

Also, when the second striker S2 is engaged with the second lock groove 39, the second striker S2 pushes the lever 25 to rotate the lever 25 from the inactivated position to the activated position, and thereby, the lever 25 pulls the cover 23 via the connecting member 26 to rotate the cover 23 from the covering position to the exposing position. Accordingly, it is possible to displace the cover 23 from the covering position to the exposing position by the attachment operation of the vehicle seat 1. Therefore, it is possible to more securely prevent the lock mechanism 6 from being activated by mistake in the state where the vehicle seat 1 is detached from the floor F.

Also, when the engagement of the first striker S1 with the first lock groove 35 and the engagement of the second striker S2 with the second lock groove 39 are released, the cover 23 rotates from the exposing position to the covering position by the urging force of the urging member 24. Accordingly, it is possible to rotate the cover 23 from the exposing position to the covering position by the detachment operation of the vehicle seat 1. Therefore, it is possible to more securely prevent the lock mechanism 6 from being activated by mistake in the state where the vehicle seat 1 is detached from the floor F.

Also, the connecting member 26 is disposed below each slide rail 4. Accordingly, it is possible to protect the connecting member 26 by each slide rail 4, and thereby to prevent the connecting member 26 from being damaged or deformed by an outside force.

Also, the cover 23 is formed in a plate shape and configured to cover only a part of the first lock groove 35 in the state where the cover 23 is disposed in the covering position. Accordingly, it is possible to make the configuration of the cover 23 simple.

### (Modification)

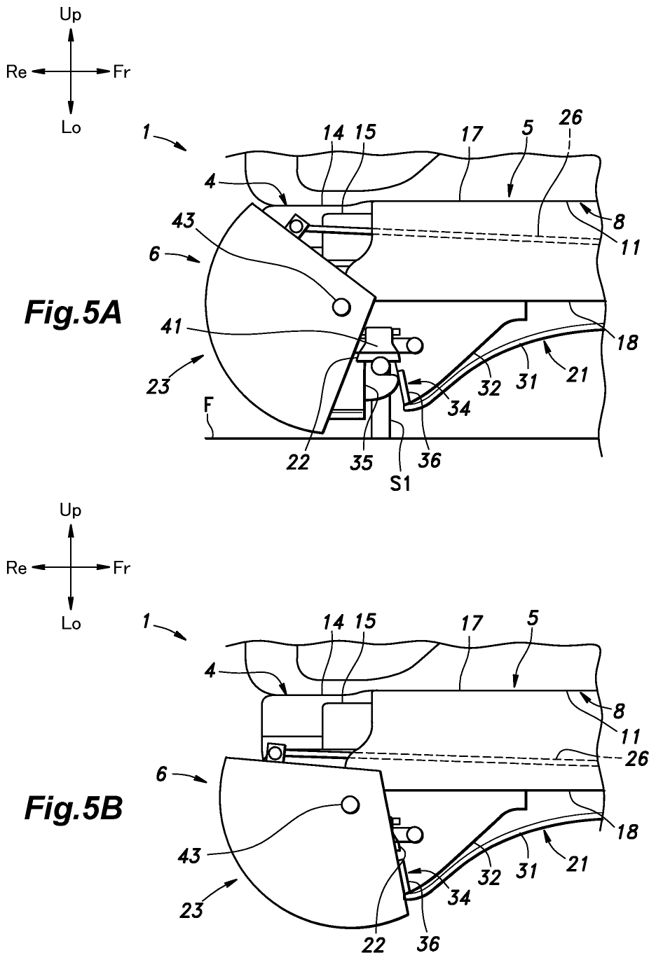

In the present embodiment, the connecting member 26 is disposed below each slide rail 4. In another embodiment, as shown in FIGS. 5A and 5B, the connecting member 26 may be disposed inside each rail cover 5. According to this arrangement, it is possible to protect the connecting member 26 by each rail cover 5, and thereby to prevent the connecting member 26 from being damaged or deformed by an outside force.

In the present embodiment, the cover 23 is formed in a plate shape and configured to cover only a part of the first lock groove 35 in the state where the cover 23 is disposed in the covering position. In another embodiment, as shown in FIGS. 5A and 5B, the cover 23 may be formed in a bag shape and configured to expose the entirety of the first lock groove 35 in a state where the cover 23 is disposed in the exposing position (see FIG. 5A) and to cover an entirety of the first lock groove 35 in a state where the cover 23 is disposed in the covering position (see FIG. 5B). According to this arrangement, it is possible to securely prevent the object other than the first striker S1 from abutting against the abutting face 56 of the latch member 27 in the state where the cover 23 is disposed in the covering position.

In the present embodiment, the connecting member 26 is composed of a cable. In another embodiment, the connecting member 26 may be composed of a member other than a cable (for, example, the connecting member 26 may be composed of a bent wire made of steel or a rod). In this case, the lever 25 may push the cover 23 via the connecting member 26 to displace the cover 23 from the covering position to the exposing position.

In the present embodiment, the first and levers 23, 25 rotate. In another embodiment, the first and levers 23, 25 may slide in the fore and aft direction.

In the present embodiment, the cover 23 exposes the entirety of the first lock groove 35 in the state where the cover 23 is disposed in the exposing position (see FIG. 1). In another embodiment, the cover 23 may not expose the entirety of the first lock groove 35 in the state where the cover 23 is disposed in the exposing position. For example, the cover 23 may expose most of the first lock groove 35 in the state where the cover 23 is disposed in the exposing position.

Concrete embodiments of the present invention have been described in the foregoing, but the present invention should not be limited by the foregoing embodiments and various modifications and alterations are possible within the scope of the present invention.

1. A vehicle seat detachably attached to a floor of a vehicle, comprising:
a seat body configured to support an occupant; and
a lock mechanism disposed below the seat body, detachably attached to a first striker provided on the floor, and including
a first lock part that has a first lock groove configured to be engaged with the first striker, and
a cover configured to be displaced between an exposing position to expose the first lock groove and a covering position to cover at least a part of the first lock groove.

2. The vehicle seat according to claim 1, wherein the lock mechanism further includes
a second lock part that has a second lock groove configured to be engaged with a second striker provided on the floor,
a lever disposed at the second lock part and configured to be displaced between an activated position and an inactivated position, and
a connecting member connecting the cover and the lever, and
when the second striker is engaged with the second lock groove, the second striker pushes the lever to displace the lever from the inactivated position to the activated position, and thereby, the lever pulls the cover via the connecting member to displace the cover from the covering position to the exposing position.

3. The vehicle seat according to claim 2, wherein the lock mechanism further includes an urging member configured to urge the cover to the covering position, and
when engagement of the first striker with the first lock groove and engagement of the second striker with the second lock groove are released, the cover is displaced from the exposing position to the covering position by an urging force of the urging member.

4. The vehicle seat according to claim 2, wherein the cover is configured to rotate between the exposing position and the covering position, and
the lever is configured to rotate between the activated position and the inactivated position.

5. The vehicle seat according to claim 4, wherein a rotational direction of the cover from the covering position to the exposing position is the same as a rotational direction of the lever from the inactivated position to the activated position.

6. The vehicle seat according to claim 4, wherein the cover includes a first upper arm extending upward from a rotational center of the cover,
the lever includes a second upper arm extending upward from a rotational center of the lever,
a first end in a longitudinal direction of the connecting member is connected to the first upper arm, and
a second end in the longitudinal direction of the connecting member is connected to the second upper arm.

7. The vehicle seat according to claim 2, wherein the lever is disposed in front of the cover, and
the connecting member is composed of a cable extending in a fore and aft direction.

8. The vehicle seat according to claim 2, wherein, in a state where the lever is disposed in the inactivated position, the lever extends in a direction crossing a direction along which the second striker engages with the second lock groove.

9. The vehicle seat according to claim 2, further comprising a slide rail configured to slidably support the seat body,
wherein the connecting member is disposed below the slide rail.

10. The vehicle seat according to claim 2, further comprising:
a slide rail configured to slidably support the seat body; and
a rail cover configured to cover at least a part of the slide rail,
wherein the connecting member is disposed inside the rail cover.

11. The vehicle seat according to claim 1, wherein the cover is formed in a bag shape and configured to cover an entirety of the first lock groove in a state where the cover is disposed in the covering position.

12. The vehicle seat according to claim 1, wherein the cover is formed in a plate shape and configured to cover only a part of the first lock groove in a state where the cover is disposed in the covering position.
